(19) United States
(12) Patent Application Publication
(10) Pub. No.: US 2010/0303569 A1
(43) Pub. Date: Dec. 2, 2010

(54) Rotating Tool for Processing Holes Provided with Cartridges Having Cutting Inserts

(75) Inventors: Eitan Gonen, Migdal Tefen (IL); Moshe Sharon, Daegu (KR); Min Gu Kim, Daegu (KR)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: TaeguTec, Ltd., Daegu (KR)

(21) Appl. No.: 12/744,865

(22) PCT Filed: Nov. 27, 2007
(86) PCT No.: PCT/KR07/06035

§ 371 Date: May 26, 2010

(51) Int. Cl. B23B 51/02

(52) U.S. Cl. 408/186; 408/229; 408/203

(57) ABSTRACT

A rotating tool includes a tool body, an outer cartridge, an inner cartridge and one or more setting plates. The tool body includes a pocket for the inner cartridge and a pocket for the outer cartridge. The outer cartridge has at least one cutting insert and a bolt through-hole extending toward a peripheral portion of the tool body. The outer cartridge is mounted on the pocket for the outer cartridge by means of a bolt. The setting plate is positioned to contact both the outer cartridge and the pocket for the outer cartridge. Screw holes for mounting the setting plate are formed on a side face of the outer cartridge adjacent to a rotating axis and through-holes are formed on the setting plate. This is so that the setting plate can be mounted on the side face of the outer cartridge by setting screws.

### TECHNICAL FIELD

The present invention generally relates to a rotating tool for processing holes, and more particularly to a rotating tool for processing holes, wherein the diameter of the hole to be processed can be adjusted.

### BACKGROUND ART

In order to process holes to a workpiece (e.g., drilling), a rotating tool provided with a plurality of cutting inserts at a distal end of the tool body is used for processing a large hole. When a portion of the cutting insert of such a tool is broken while it is in use, the broken cutting insert and the broken piece may cause an impact, which can be directly transmitted to the tool body. This can cause a severe damage to the expensive tool body.

In order to solve such a problem, a cartridge having a cutting insert is mounted on the tool body, rather than mounting a cutting insert directly onto the tool body. Thus, the tool body can be prevented from damage caused by breakage of the cutting insert.

FIGS. 1 and 2 illustrate a conventional rotating tool, wherein cartridges having cutting inserts are mounted thereto. The rotating tool of FIGS. 1 and 2 includes a tool body 11 and two cartridges 12 and 13. Grooves for discharging chips are formed on the peripheral portion of the tool body 11, while pockets 16, 17 for mounting the cartridges 12 and 13 are formed at the distal end of the tool body. Cutting inserts 14 and 15 are mounted on the cartridges 12 and 13, respectively. The inner cartridge 12 is mounted in the proximity of the rotating axis of the tool body 11, whereas the outer cartridge 13 is mounted on the peripheral portion of the tool body 11. When the tool body 11 provided with the inner and outer cartridges 12 and 13 rotates relative to the workpiece, the rotational trace of the cutting insert 15 of the outer cartridge 13 partially overlaps with that of the cutting insert 14 of the inner cartridge 12. Thus, the cutting range of the workpiece is divided by each of the cutting inserts 14 and 15. The diameter of the hole, which is on the workpiece to be processed, is determined by the cutting insert 15 of the outer cartridge 13.

In the rotating tool of the prior art, the outer cartridge having a size corresponding to the diameter of the hole to be processed is selected and mounted. For example, in order to process a hole greater than the hole processed with an existing outer cartridge, a clamping bolt is released to remove the existing outer cartridge. Further, an outer cartridge, on which a cutting insert is provided far outward than with the existing outer cartridge, is mounted on the pocket for the outer cartridge. Likewise, when the diameter of the hole to be processed needs to be smaller, an outer cartridge, which is provided with a cutting insert far inward than with the existing outer cartridge, may be mounted on the pocket for the outer cartridge.

Such a rotating tool of the prior art should be provided with a number of outer cartridges having various mounting positions of the cutting inserts so that the diameter of the hole to be processed can be adjusted. Accordingly, it is difficult to maintain the rotating tool of the prior art and the associated costs are also high.

### DISCLOSURE

### Technical Problem

It is an object of the present invention to provide a rotating tool for processing holes, wherein the diameter of the hole to be processed can be adjusted, without any need to change the cartridge to thereby solve the problem of the prior art.

### Technical Solution

In order to achieve the above object, the present invention provides a rotating tool for processing a hole, comprising: a tool body; an outer cartridge; an inner cartridge; and setting plates. The tool body is capable of being rotated about a rotating axis and has at least one chip discharge groove at its peripheral portion. The outer cartridge has at least one cutting insert and a bolt through-hole. The inner cartridge has at least one cutting insert and a bolt through-hole. The setting plates have a thin flat shape. The tool body includes a pocket for the inner cartridge, which is formed adjacent to the rotating axis at a distal end of the tool body. It also includes a pocket for the outer cartridge, which is formed adjacent to the peripheral portion of the tool body at the distal end of the tool body. The inner cartridge is mounted on the pocket for the inner cartridge by means of a bolt. The outer cartridge is mounted on the pocket for the outer cartridge by means of a bolt. The bolt through-hole of the outer cartridge extends toward the peripheral portion of the tool body. The setting plate is positioned to contact both the outer cartridge and the pocket for the outer cartridge. Screw holes for mounting the setting plate are formed on a side face of the outer cartridge adjacent to the rotating axis and through-holes are formed on the setting plate. Thus, the setting plate can be mounted on the side face of the outer cartridge by setting screws.

The setting plate may be selected from a set of setting plates including a plurality of setting plates each having a different thickness.

Concave portions for receiving heads of the setting screws are formed on a side face of the pocket contacting the setting plate mounted on the side face of the outer cartridge.

The cutting insert of the inner cartridge is inclined in a positive direction about the rotating axis of the tool body.

The pocket of the tool body for the inner cartridge includes a support wall for supporting an outer wall of the inner cartridge.

Inner and outer cutting inserts are mounted on the inner cartridge. An outer corner cutting edge of the outer cutting insert protrudes outwardly from the outer wall of the inner cartridges. A receiving portion for receiving the protrusion of the outer cutting insert is formed on the support wall of the pocket for the inner cartridge.

Depressed portions are formed on a center of bottom faces of the pockets for the inner and outer cartridges.

### DESCRIPTION OF DRAWINGS

FIG. 1 illustrates a conventional rotating tool on which cartridges having cutting inserts are mounted.

FIG. 2 illustrates the bottom of the conventional rotating tool.

FIG. 3 is a perspective view of a rotating tool according to an embodiment of the present invention.

FIG. 4 illustrates an outer cartridge separated from the rotating tool and setting plates for mounting on a side face of the outer cartridge according to an embodiment of the present invention.

FIG. 5 is an enlarged view of a pocket for the outer cartridge of the rotating tool according to an embodiment of the present invention.

FIGS. 6 to 8 illustrate various mounting positions of the outer cartridge in the rotating tool according to an embodiment of the present invention.

FIG. 9 illustrates an inner cartridge mounted on the pocket of the rotating tool according to an embodiment of the present invention.

FIG. 10 illustrates the rotating tool wherein the cutting inserts are removed from the inner cartridge according to an embodiment of the present invention.

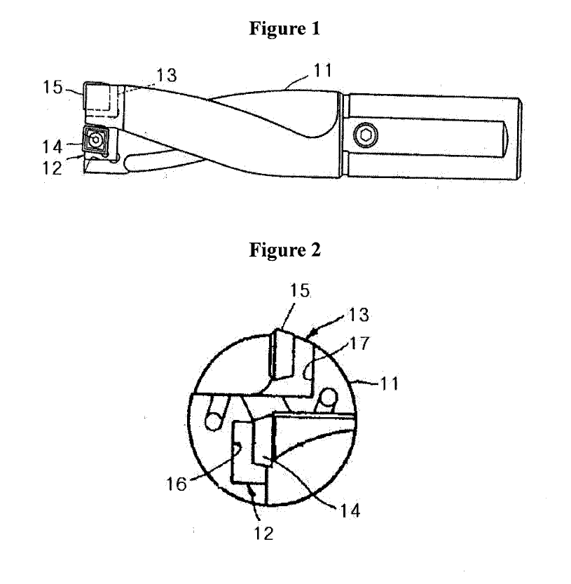

### BEST MODE FOR CARRYING OUT THE INVENTION

A rotating tool according to one embodiment of the present invention will now be described with reference to the accompanying drawings.

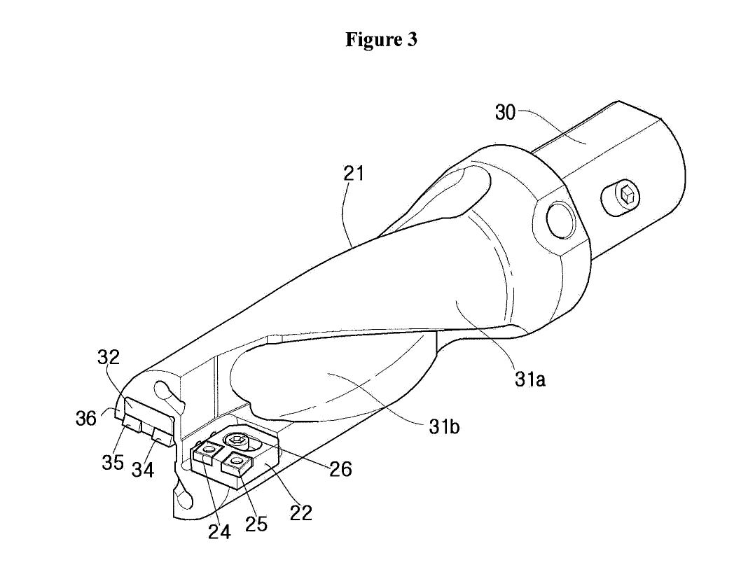

FIG. 3 is a perspective view of the rotating tool according to an embodiment of the present invention. Referring to FIG. 3, the rotating tool of the present invention comprises a tool body 21 rotatable about a rotating axis, an outer cartridge 22 and an inner cartridge 32. The tool body includes a shank 30 for connection to a spindle (not shown) of a machine. A pair of ribs 31a, which spirally extend on a peripheral portion of the tool body 21, define a pair of spiral chip discharge grooves 31b. Further, a feed way for lubricant and coolant is provided at the tool body and a discharge port for lubricant and coolant is formed at a distal end of the tool body.

A pocket 33 for mounting the inner cartridge 32 thereon is formed at the distal end of the tool body adjacent to the rotating axis of the tool body 21. The pocket 33 for the inner cartridge includes the following: a bottom face; an inner wall for supporting an inner side of the inner cartridge 32; a top wall for supporting an upper side of the inner cartridge; and an outer wall 36 (a support wall) for supporting an outer side of the inner cartridge 32. A pocket 23 for mounting the outer cartridge 22 thereon is formed at the distal end of the tool body adjacent to the peripheral portion of the tool body 21. That is, the pocket 23 for the outer cartridge is located farther away from the rotating axis of the tool body 21 compared to the pocket 33 of the inner cartridge. The pocket 23 for the outer cartridge includes the following: a bottom face; an inner wall for supporting an inner side of the outer cartridge 22; and a top wall for supporting an upper side of the outer cartridge.

Bolt through-holes are formed at the middle of the outer cartridge 22 and the inner cartridge 32, respectively. Two cutting inserts are mounted to each of the cartridges. In the embodiment illustrated in FIG. 3, two cutting inserts are mounted to each of the outer and inner cartridges 22, 32. However, the present invention should not be limited to such mounting construction. The inner cartridge 32 is mounted to the pocket 33 for the inner cartridge and can be secured thereto by means of a bolt. The outer cartridge 22 is mounted to the pocket 23 for the outer cartridge and can be secured thereto by means of a bolt. When a hole is processed by rotating the rotating tool 20 relative to a workpiece, the rotary trace of the cutting inserts mounted on the inner cartridge 32 partially overlaps with that of the cutting insert mounted on the outer cartridge 22. Specifically, the cutting insert 34 mounted to the innermost side of the inner cartridge 32 processes a central portion of a hole, while the cutting insert 24 mounted to an innermost side of the outer cartridge processes a portion that is further outer than the central portion. The rotary trace of the cutting insert 34 partly overlaps with that of the cutting insert 24. Further, the cutting insert 35 outwardly mounted on the inner cartridge 32 processes a far outer portion as its rotary trace partly overlaps with that of the cutting insert 24. The cutting insert 25 outwardly mounted on the outer cartridge 22 processes an outermost portion of a hole to be processed. Thus, a diameter of a hole to be processed is determined by the cutting insert 25 outwardly mounted to the outer cartridge 22.

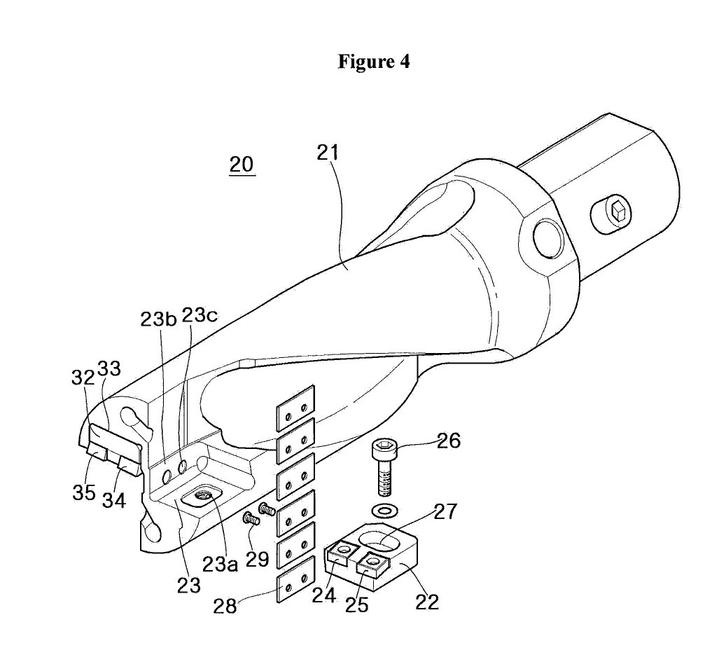

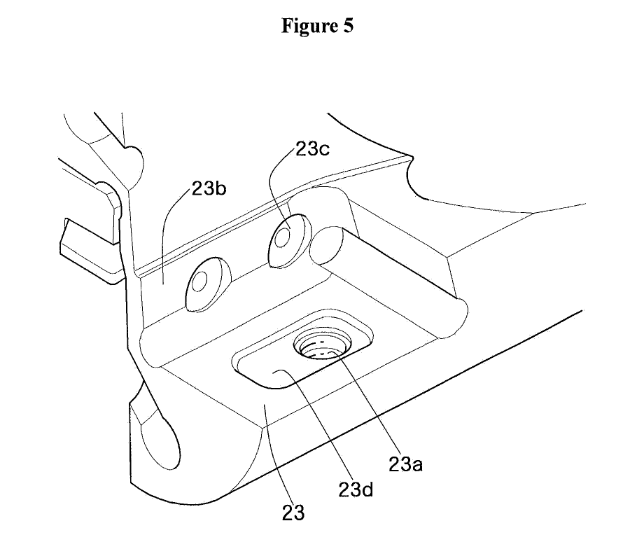

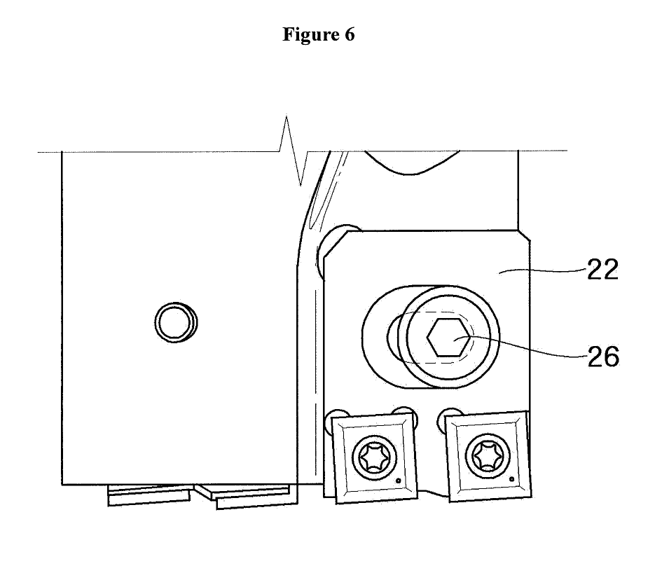

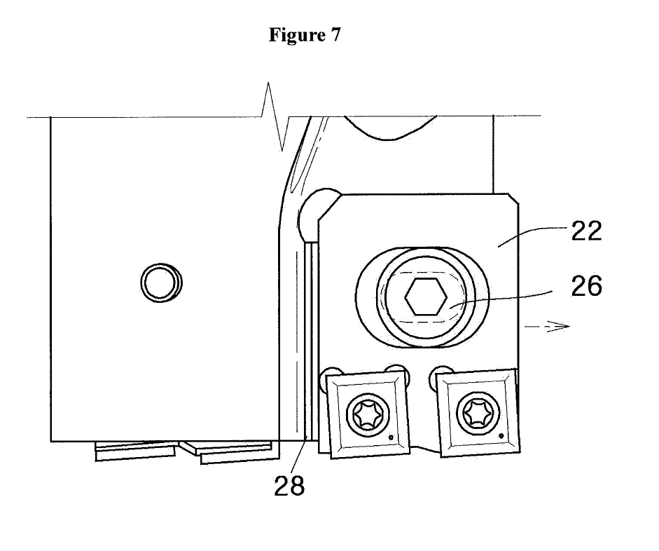

FIG. 4 illustrates the outer cartridge separated from the rotating tool and setting plates attached to a side face of the outer cartridge. FIG. 5 is an enlarged view of the pocket for the outer cartridge. FIGS. 6 to 8 illustrate various mounting positions of the outer cartridge. Referring to FIGS. 4 and 5, a screw hole 23a, to which a bolt 26 is fixed, is formed on the bottom face of the pocket 23 for the outer cartridge, on which the outer cartridge 22 is mounted. A through-hole 27 formed at the outer cartridge 22 elongatedly extends toward the peripheral portion of the tool body 21. Such a configuration of the through-hole 27 of the outer cartridge 22 allows the outer cartridge 22 to be secured to the pocket 23 of the tool body 21 by means of the bolt 26, although the outer cartridge 22 is radially moved from the rotating axis of the tool body 21.

Thin plate-shaped setting plates 28 having different thicknesses are provided to vary the mounting position of the outer cartridge 22. In order to radially and outwardly move the outer cartridge 23b closely contacting the side face 23b of the pocket 23 for the outer cartridge and mount the outer cartridge 23b to such a position, the setting plate 28, which has a thickness corresponding to a movement distance of the outer cartridge, is selected from a set of setting plates including a plurality of setting plates with different thicknesses, and is then employed. Screw holes for fixing the setting plate are formed on the side face of the outer cartridge 22. Through-holes corresponding to such screw holes are formed at the setting plate 28. First, the bolt 26 is unfastened and the outer cartridge 22 mounted to the pocket 23 is separated thereby. Then, the setting plate 28 with a predetermined thickness is mounted to the side face of the outer cartridge 22 by means of the setting screws 29. Subsequently, when the outer cartridge 22 with the setting plate 28 mounted thereto is disposed in the pocket 23, the setting plate 28 is brought into contact with both the outer cartridge 22 and the side face of the pocket 23 for the outer cartridge. Thus, the outer cartridge 22 is positioned as it is being moved toward the peripheral portion of the tool body 21 by the thickness of the setting plate 28 when compared to its initial mounting position. Since the through-hole 27 of the outer cartridge 22 extends toward the peripheral portion of the tool body 21, the outer cartridge 22 may be secured to the pocket 23 of the tool body 21 by means of the bolt 26 when the outer cartridge 22 is moved toward the peripheral portion of the tool body 21.

Further, as shown in FIG. 5, concave portions 23c are formed on the side face of the pocket 23 for the outer cartridge. The heads of the setting screws 29 can be received in the concave portions 23c. Thus, when the setting plate 28 is mounted to the side face of the outer cartridge 22 by means of the setting screws 29 and such a combination is mounted to the pocket 23 for the outer cartridge, the heads of the setting screws 29 can be received in the concave portions 23c formed on the side face of the pocket 23. This allows the face of the setting plate 28 to be in close contact with the side face 23b of the pocket 23, thereby providing firm and non-oscillating secureness of the outer cartridge 22 while processing a hole to a workpiece.

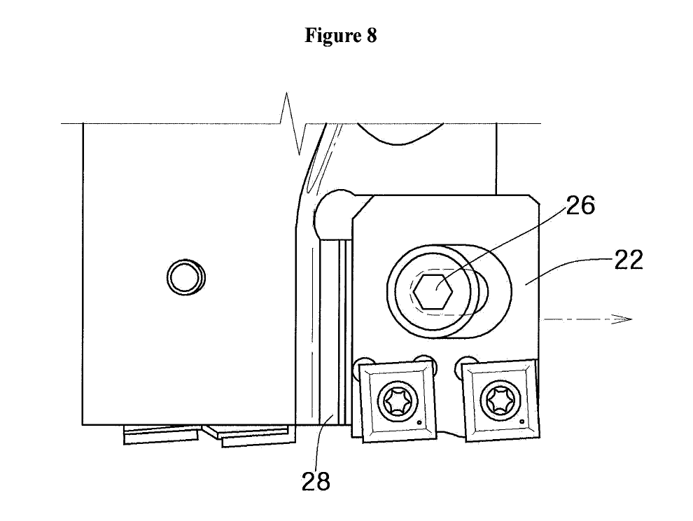

Since the mounting positions of the outer cartridge 22 can be adjusted by using the setting plate 28 as described above, the diameter of a hole to be processed by the rotating tool can be adjusted accordingly. Further, since the thickness of the setting plate 28, which is configured to be attached to the side face of the outer cartridge 22, can be selected diversely, the diameter of the hole to be processed by the rotating tool can be selected diversely as well. As shown in FIG. 6, the hole of the workpiece may be processed when the side face of the outer cartridge 22 is in close contact with and fixed to the side face 23b of the pocket 23 without any setting plate 28 attached to the side face of the outer cartridge 22. Further, as shown in FIG. 7, the diameter of the hole to be processed can be increased by selecting the setting plate 28 with a desired thickness from the setting plate set and then mounting the side face of the outer cartridge 22. Furthermore, when a greater hole needs to be processed, a still thicker setting plate 28 may be mounted to the side face of the outer cartridge 22, as shown in FIG. 8.

Meanwhile, as discussed above, the through-hole 27, through which the bolt passes, is formed at the outer cartridge 22, while the threaded hole 23a is formed at the pocket 23 of the tool body. That is, the bolt 26 passes through the outer cartridge 22 and is then tread-engaged to the hole 23a. Alternatively, in case a through-hole passing through the bottom face of the pocket is formed at the tool body and a threaded hole is formed at the outer cartridge, a clamping bolt would be fitted to the peripheral portion of the tool body and be thread-engaged to the hole formed at the outer cartridge. However, in case the threaded hole is formed to the outer cartridge, the number of threads of the hole to be engaged to the clamping bolt is decreased, compared to forming the threaded hole to the pocket of the tool body according to the present invention. Accordingly, as for firm secureness of the outer cartridge, it is preferable that the through-hole is formed at the outer cartridge and the threaded hole is formed at the pocket of the tool body, thereby allowing the clamping bolt to pass through the outer cartridge and to be thread-engaged to the hole formed at the pocket. This is likewise applied to securing the inner cartridge by means of a clamping bolt.

The bottom face of the outer cartridge 22 and the bottom face of the pocket 23 are processed to be flat. However, if any one of the bottom face of the outer cartridge 22 and the bottom face of the pocket 23 is not flat processed (particularly if a central portion of the bottom face of the pocket is formed somewhat upwardly and convexly), then the outer cartridge 22 fails to closely contact the bottom face of the pocket 23, thereby causing oscillation of the cartridge while processing the workpiece and further damage on the rotating tool. In order to avoid such a problem, it is very important to precisely process the bottom faces of the outer cartridge 22 and the pocket 23. However, a significant amount of time and costs are required for processing the bottom face of the outer cartridge 22 and the bottom face of the pocket 23 so precisely that they can be closely contacted to each other thoroughly.

According to the present invention, a depressed portion 23d is formed in the middle of the bottom face of the pocket, as shown in FIG. 5. The depressed portion 23d does not permit the entire bottom face of the outer cartridge 22 and the entire bottom face of the pocket 23 to be contacted to each other. Rather, the bottom face of the outer cartridge 22 is permitted to contact only a peripheral portion of the pocket 23. Thus, the oscillation phenomenon of the outer cartridge 22 while processing holes can be prevented to a considerable extent. Although not shown in FIG. 5, the depressed portion is likewise formed on the bottom face of the pocket for the inner cartridge.

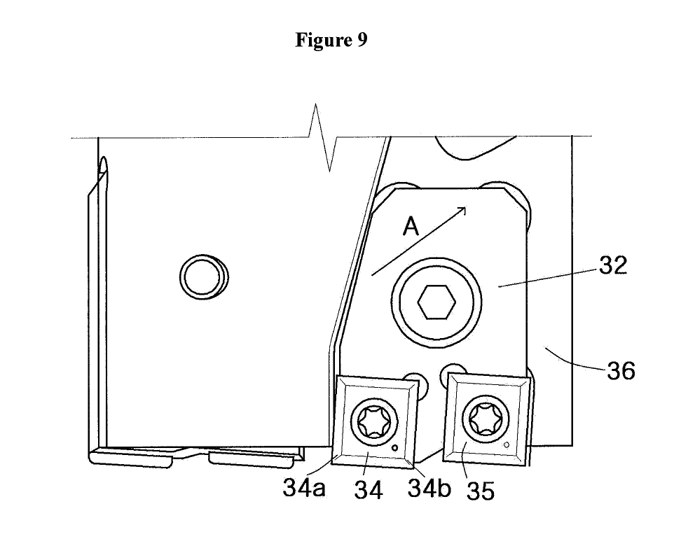

FIG. 9 illustrates the inner cartridge mounted on the pocket for the inner cartridge of the rotating tool. A corner cutting edge 34a of the cutting insert 34, which is mounted inwardly on the inner cartridge 32, is positioned at a center of the hole to be processed. A rotational speed of the rotating tool relative to the workpiece becomes nearly zero at the corner cutting edge 34a. Thus, if the corner cutting edge 34a of the cutting insert 34 of the inner cartridge 32 first contacts the workpiece when the rotating tool approaches the workpiece while rotating, the corner cutting edge 34a cannot withstand a load applied by the workpiece and may be broken. This is because the workpiece applies a large load to the corner cutting edge 34a and the rotation speed at the corner cutting edge 34a becomes zero. As such, the cutting insert 34 of the inner cartridge 32 is mounted and inclined in a positive direction relative to the rotating axis of the tool body, as shown in FIG. 9. In case the cutting insert is mounted in such a manner, when the rotating tool approaches the workpiece while rotating, the cutting insert 34 is first contacted to the workpiece at its corner cutting edge 34b (not at its corner cutting edge 34a) and is gradually contacted to the workpiece throughout its inclined cutting edge. Consequently, when a hole is initially processed, the corner cutting edge 34a can be prevented from breaking due to the large load caused by contacting the workpiece.

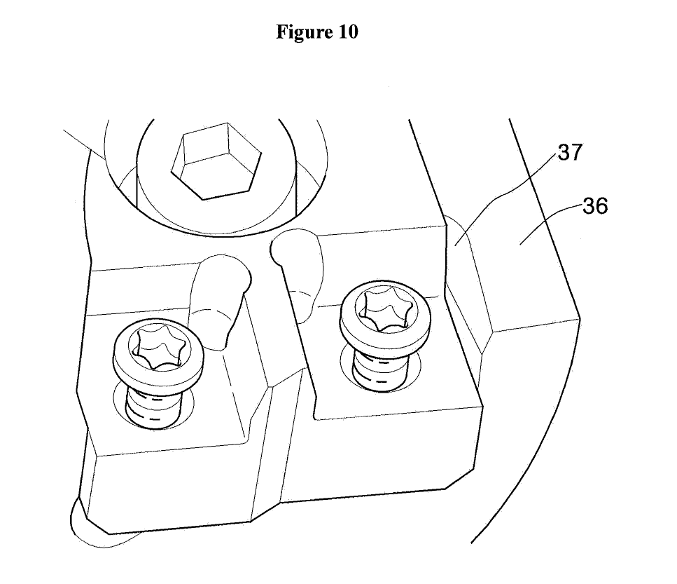

Further, in case the cutting insert is mounted to the inner cartridge 32 in a way of being inclined in the positive direction relative to the rotating axis of the tool body, a reaction force acts on the inner cartridge 32 in a direction of an arrow A due to the workpiece, as shown in FIG. 9. Accordingly, the support wall 36 is formed at the pocket 33 for the inner cartridge 32 for supporting the inner cartridge 32 that is subjected to the force in the direction of the arrow A. The support wall 36 can firmly support the inner cartridge 32 within the pocket 33. It is preferable that the support wall 36 of the pocket 33 for the inner cartridge is as thick as possible to support the inner cartridge 32 more firmly. To this end, according to the present invention, an outer corner cutting edge of the cutting insert 35 protrudes outwardly from the outer wall of the inner cartridge 32. That is, the outer wall of the inner cartridge 32 is located inwardly from the outer corner cutting edge of the cutting insert 35. On the other hand, a receiving portion 37 is formed on the support wall 36 of the pocket 33 for the inner cartridge. The receiving portion 37 receives the protrusion of the outer cutting edge 35. As a result, the thickness of the support wall 36 can be more increased. FIG. 10 shows the inner cartridge from which the cutting inserts are removed and further shows the receiving portion 37 formed on the support wall 36.

While the present invention has been described by way of preferred embodiments thereof, those embodiments are for exemplary purposes only. It will be understood by those of ordinary skill in the art that various alternations or modifications may be made without departing from the scope of the present invention. For example, it is described in an embodiment of the present invention that the mounting positions of the outer cartridge are changed by replacing the setting plates having different thicknesses. However, the mounting position of the outer cartridge may be changed by combining the setting plates having an equal thickness and attaching such a combination to the outer cartridge.

### INDUSTRIAL APPLICABILITY

In the rotating tool for processing holes according to the present invention, it is unnecessary to replace an outer cartridge with another one for adjusting the diameter of a hole to be processed. That is, the setting plate with a predetermined thickness is mounted on the side face of the outer cartridge and the outer cartridge with the setting plate is mounted on the pocket for the outer cartridge. The outer cartridge may be mounted on the position to which is moved by the thickness of the setting plate. Further, since the bolt through-hole extending elongatedly toward the peripheral portion of the tool body is formed at the outer cartridge, although the outer cartridge is radially outwardly moved from the rotating axis of the tool body, the outer cartridge can be firmly secured to the pocket by passing the bolt through the bolt through-hole and then fastening it to the screw hole formed at the pocket.

The concave portions are formed on the side face of the outer cartridge. The heads of the setting screws for use in attaching the setting plate to the outer cartridge can be received in the concave portions. Thus, although it protrudes beyond the face of the setting plate, the head of the setting screw is received in the concave portion of the side face of the pocket. The face of the setting plate is permitted to be in close contact with the side face of the pocket. Further, the outer cartridge can be firmly secured to the tool body without any oscillation while processing a workpiece.

Moreover, according to the present invention, the hole formed at the tool body has more threads than a conventional rotating tool in which a tool body has a through-hole therethrough and an outer cartridge to be secured to such a tool body has a screw hole therethrough. Thus, according to the present invention, the outer cartridge may be more firmly secured to the tool body.

The cutting insert of the inner cartridge is mounted and inclined in a positive direction relative to the rotating axis of the tool body. Thus, when a hole is processed at a workpiece, an inner corner cutting edge of the cutting insert, which is positioned at a center of the tool body, is not permitted to first contact the workpiece. Rather, an opposite outer corner cutting edge of the cutting insert is permitted to first contact the workpiece. As a result, the chance of breaking the corner cutting edge positioned at the center of the tool body due to a heavy load applied by the workpiece can be decreased. Further, when the cutting insert of the inner cartridge is mounted and inclined in a positive direction of the rotating axis of the tool body, a reaction force acts on the inner cartridge toward the peripheral portion of the tool body due to a workpiece. Accordingly, the support wall is formed at the pocket for the inner cartridge to firmly support the inner cartridge subjected to the reaction force acting toward the peripheral portion of the tool body.

Further, the outer corner cutting edge of the outer cutting insert, which is mounted to the inner cartridge, protrudes outwardly from the outer wall of the inner cartridge toward the outer periphery. On the other hand, the receiving portion for receiving the protrusion of the outer cutting edge is formed on the support wall of the pocket for the inner cartridge. Thus, the support wall, which supports the inner cartridge against the reaction force acting thereon toward the peripheral portion of the tool body, can be formed thicker. As a result, the inner cartridge may be supported more firmly.

The depressed portions are formed in the middle of the bottom faces of the pockets, which are brought into close contact with the bottom faces of the outer and inner cartridges. Since the bottom face of the cartridge can be in close contact with the peripheral marginal portion of the bottom face of the pocket, the oscillation phenomenon of the cartridges, which may occur when the bottom faces of the pockets are processed precisely, can be prevented.

1. A rotating tool for processing a hole, comprising:
a tool body configured to rotate about a rotating axis and having at least one chip discharge groove at its peripheral portion;
an outer cartridge having at least one cutting insert and a bolt through-hole;
an inner cartridge having at least one cutting insert and a bolt through-hole; and
at least one setting plate formed in a thin flat shape;
wherein said tool body includes a pocket for the inner cartridge formed adjacent to the rotating axis and at a distal end of the tool body, and wherein a pocket for the outer cartridge is formed adjacent to the peripheral portion of the tool body and at the distal end of the tool body;
said inner cartridge is mounted on the pocket for the inner cartridge by means of a bolt;
said outer cartridge is mounted on the pocket for the outer cartridge by means of a bolt;
said bolt through-hole of the outer cartridge extends toward the peripheral portion of the tool body;
said at least one setting plate is positioned to contact both the outer cartridge and the pocket for the outer cartridge; and
screw holes for mounting the at least one setting plate are formed on a side face of the outer cartridge adjacent to the rotating axis and through-holes are formed on the at least one setting plate so that the at least one setting plate can be mounted on the side face of the outer cartridge by setting screws.

2. The rotating tool of claim 1, wherein said at least one setting plate is selected from a setting plate set comprised of a plurality of setting plates each having a different thickness.

3. The rotating tool of claim 1, wherein concave portions for receiving heads of the setting screws are formed on a side face of the pocket contacting the at least one setting plate mounted on the side face of the outer cartridge.

4. The rotating tool of claim 1, wherein the cutting insert of the inner cartridge is inclined in a positive direction about the rotating axis of the tool body.

5. The rotating tool of claim 4, wherein the pocket of the tool body for the inner cartridge includes a support wall for supporting an outer wall of the inner cartridge.

6. The rotating tool of claim 5, wherein inner and outer cutting inserts are mounted on the inner cartridge so that an outer corner cutting edge of the outer cutting insert forms a protrusion that protrudes outwardly from the outer wall of the inner cartridge and a receiving portion for receiving the protrusion is formed on the support wall of the pocket for the inner cartridge.

7. The rotating tool of claim 1, wherein depressed portions are formed on a center of bottom faces of the pockets for the inner and outer cartridges.

8. The rotating tool of claim 2, wherein concave portions for receiving heads of the setting screws are formed on a side face of the pocket contacting the at least one setting plate mounted on the side face of the outer cartridge.

9. The rotating tool of claim 2, wherein the cutting insert of the inner cartridge is inclined in a positive direction about the rotating axis of the tool body.

10. The rotating tool of claim 9, wherein the pocket of the tool body for the inner cartridge includes a support wall for supporting an outer wall of the inner cartridge.

11. The rotating tool of claim 10, wherein inner and outer cutting inserts are mounted on the inner cartridge so that an outer corner cutting edge of the outer cutting insert forms a protrusion that protrudes outwardly from the outer wall of the inner cartridge and a receiving portion for receiving the protrusion is formed on the support wall of the pocket for the inner cartridge.

12. The rotating tool of claim 2, wherein depressed portions are formed on a center of bottom faces of the pockets for the inner and outer cartridges.

13. A rotating tool for processing a hole, comprising:
a tool body configured to rotate about a rotating axis, the tool body having at least one chip discharge groove at a peripheral portion thereof, a distal end of the tool body having an inner pocket formed adjacent the rotating axis and an outer pocket formed adjacent to the peripheral portion;
an outer cartridge mounted on the outer pocket, the outer cartridge having an elongated bolt through-hole which extends towards the peripheral portion of the tool body, a side face of the outer cartridge adjacent to the rotating axis being provided with screw holes;
an inner cartridge mounted on the inner pocket, the inner cartridge having a bolt through hole;
at least one cutting insert mounted on the outer cartridge;
at least one cutting insert mounted on the inner cartridge;
a spacer positioned to contact both said side face of the outer cartridge and a side face of the outer pocket, the spacer comprising one or more setting plates, each setting plate formed in a thin flat shape and having spaced apart through holes; and
a plurality of setting screws passing through the spaced apart through holes of the one or more setting plates and into the screw holes formed on said side face of the outer cartridge, thereby mounting the spacer onto the outer cartridge.

14. The rotating tool of claim 13, wherein:
the side face of the outer pocket contacted by the spacer is provided with concave portions and heads of the setting screws are received into the concave portions.

15. The rotating tool of claim 13, wherein the cutting insert of the inner cartridge is inclined in a positive direction about the rotating axis of the tool body.

16. The rotating tool of claim 13, wherein the inner pocket includes a support wall for supporting an outer wall of the inner cartridge.

17. The rotating tool of claim 16, wherein inner and outer cutting inserts are mounted on the inner cartridge so that an outer corner cutting edge of the outer cutting insert forms a protrusion that protrudes outwardly from the outer wall of the inner cartridge and a receiving portion for receiving the protrusion is formed on the support wall of the inner pocket.

18. The rotating tool of claim 13, wherein depressed portions are formed on a center of bottom faces of the inner and outer pockets.

19. The rotating tool of claim 13, wherein:
the side face of the outer pocket contacted by the spacer is provided with concave portions and heads of the setting screws are received into the concave portions;
the cutting insert of the inner cartridge is inclined in a positive direction about the rotating axis of the tool body;
the inner pocket includes a support wall for supporting an outer wall of the inner cartridge;
inner and outer cutting inserts are mounted on the inner cartridge so that an outer corner cutting edge of the outer cutting insert forms a protrusion that protrudes outwardly from the outer wall of the inner cartridge and a receiving portion for receiving the protrusion is formed on the support wall of the inner pocket; and
depressed portions are formed on a center of bottom faces of the inner and outer pockets.
